(19) United States
(12) Patent Application Publication
(10) Pub. No.: US 2010/0042489 A1
(43) Pub. Date: Feb. 18, 2010

(54) Method and system for incentivizing savings

(76) Inventors: J. Houston Cook, Birmingham, AL (US); Scott M. Peters, Birgmingham, AL (US); Travis C. Vanlandingham, Gardendale, AL (US)

Correspondence Address: STEPTOE & JOHNSON LLP, 1330 CONNECTICUT AVENUE, N.W., WASHINGTON, DC, 20036, US

(21) Appl. No.: 12/540,932

(22) Filed: Aug. 13, 2009

Related U.S. Application Data
(60) Provisional application No. 61/088,622, filed on Aug. 13, 2008.

(51) Int. Cl. G06Q 30/00; G06Q 40/00

(52) U.S. Cl. 705/14.17

(57) ABSTRACT

A method and system for incentivizing savings is provided by awarding a bonus upon receiving a number of recurring transfers during a period of time.

### CLAIM OF PRIORITY

This application claims priority to U.S. Provisional Application No. 61/088,662 filed Aug. 13, 2008, which is incorporated by reference in its entirety.

### TECHNICAL FIELD

The invention relates to a method for incentivizing savings.

### BACKGROUND

Many financial institutions, including banks and savings & loans, offer savings accounts where customers accrue a positive balance through deposits. Interest is payed on the positive balance. Typically, withdrawals are allowed from a savings account, but withdrawals in excess of the balance are not allowed. A consumer can save funds in a savings account by making deposits into the account or by transferring funds from another account.

### SUMMARY OF THE INVENTION

A method for incentivizing savings can include receiving a recurring transfer from a first account to a second account, determining a number of recurring transfers received, and adding a bonus to the second account calculated from an average balance of the second account, the bonus being added when the number of recurring transfers received is above a threshold during a period of time, thereby rewarding loyalty. The received recurring transfer can be pre-planned or programmed.

In one aspect, a system for incentivizing savings can include first account; a second account, receiving a recurring transfer from the first account; and a calculation module configured to determine a number of recurring transfers received, and add a bonus to the second account calculated from a balance of the second account when the number of recurring transfers received is above a threshold during a period of time, thereby rewarding loyalty.

The details of one or more embodiments are set forth in the accompanying drawings and the description below. Other features, objects, and advantages will be apparent from the description and drawings, and from the claims.

### BRIEF DESCRIPTION OF THE DRAWING

FIG. 1 is a block diagram illustrating a system for incentivizing savings.

### DETAILED DESCRIPTION

Although the following detailed description contains many specific details for the purposes of illustration, anyone of ordinary skill in the art will appreciate that many variations and alterations to the following details can be incorporated in the system and methods described herein. Accordingly, the exemplary embodiments described below are set forth without any loss of generality to, and without imposing limitations upon, any claimed invention.

A typical bank customer may make an initial deposit into an account and then ignore or forget the account. Banks seek ways to encourage account-holders to use their accounts and deposit funds. Recurring transfers can be set up from another account. A system and method for incentivizing savings can reward use of the account and loyalty to the account holder.

A detailed explanation of the method and process according to preferred embodiments of the present invention are described below.

Recent surveys point to consumer concerns about the economy and the adequacy of their savings, all against the backdrop of their increasing interest in products that are affordable and environmentally friendly (Pew Research Center and Conference Board). Products that address these issues can be found at a bank.

The benefits of the new bonus-oriented checking and savings accounts go beyond simply providing basic banking services and financial planning. The new product set encourages—and rewards—vital savings life skills. And the new bonus products provide more—some peace of mind knowing that the account helps consumers save money while also doing something good for the environment.

Savings accounts have been around for years but the recent economic slowdown has reiterated the need for more creative and convenient savings options. A bonus checking account includes the option to open a new bonus savings account. Available with bonus checking, the bonus savings account provides a per year savings bonus, based on the account's average monthly balance and the establishment of a monthly automatic transfer from a bonus checking account.

A difficult economy is a reminder of why saving is so important—to prepare for rainy days. Personal savings are at all-time lows. This is an opportunity that banks and consumers can address together. The bonus savings account is designed to make saving incredibly simple by automating the process.

While the added saving represents a small step toward a greener financial outlook, bonus accounts also provide consumers the opportunity to make the world a bit greener.

Bonus checking is more than just a way of making banking simple and convenient for customers. It also includes—at no cost to consumers—the bank's most requested and most environmentally friendly products and e-services including one or more of recycled checks, direct deposit, check cards, online banking, online bill payment, and online statements, each of which independently can be free to the customer.

Bonus checking can come in three versions - standard, senior and student. Additional free and discounted services can be available for the later two groups. In addition, with approved credit, bonus account holders qualify for financing discounts on energy efficient home improvements and alternative fuel vehicles.

As an example, here is a quick breakdown of some of the green paybacks of bonus checking:
Online Bill Payment services save families, on average, $60 per year in postage.
Online Statements, delivered securely via email, saved more than 2,000 trees in the last year. For each customer who uses Online Statements, the paper savings alone is approximately 100 pages per year.
CheckCards often eliminate the need for paper checks. Switching to electronic transactions not only saves the typical family at least $40-$50 annually, but it also reduces overall paper consumption by 70 pages of paper per year

According to a recent study, if one household in five made a switch to making electronic billing, statements and payments, the savings per year would be in excess of 150 million pounds of paper, and preserve more than 12,000 acres of land from deforestation.

The opening of an account can be further incentivized with a gift, for example, a reusable grocery tote.

Everyone can all take simple, meaningful actions to make life better. The bonus accounts represent a step that to help people conserve both their money and natural resources.

In an embodiment, an automatic monthly transfer of $10 from a bonus checking to bonus savings for 12 consecutive months is required to earn a 1% savings rate bonus. The bonus is paid on the average monthly balance for the year and paid on the anniversary of account opening. While $10 has been used as an example, the automatic transfer can be more or less than that amount, and can vary. Additionally, the transfer can be manually requested rather than automatic.

The automatic transfer may be another time than monthly, such as weekly, bi-weekly, quarterly, etc. For a monthly transfer, during a one year period, twelve transfers will incur a bonus. However, a grace of one, two, or more missed transfers will allow a bonus even if less than twelve transfers are made. During a shorter or longer period, such as 6 months, 10 months, 14 months, etc., an optional grace of one, two, or more missed transfers may be implemented to allow a bonus even if less than the total number of transfers are made.

As described above, the bonus is a 1% bonus calculated from an average monthly balance during the time period. However, the bonus can be a different percentage, such as 0.5%, 2%, 3% or more, or can be a fixed or variable dollar amount related to or independent of the average monthly balance. Additionally, the bonus can be calculated using a minimum or maximum balance during the time period, or by using a different method.

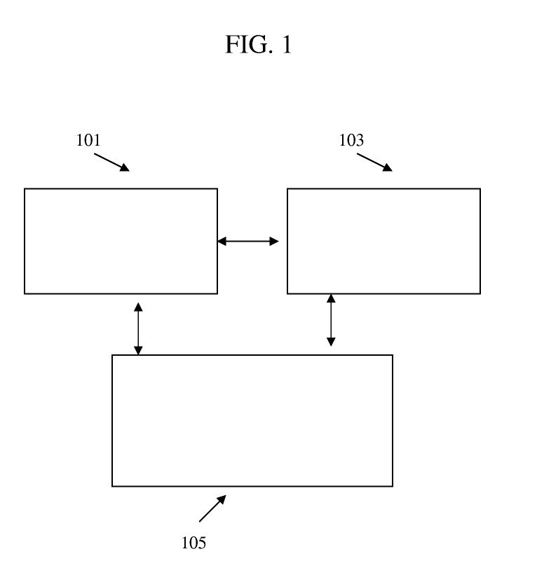

Referring to FIG. 1, there is illustrated a block diagram of a system of incentivizing savings. In FIG. 1, a first account 101 is linked to a second account 103, which may be located at the same bank or financial institution, or at a different bank or financial institution. A calculation module 105 is in communication with both the first account 101 and the second account 103. The calculation module 105 monitors the transfers from the first account 101 to the second account 103. The calculation module 105 may initiate or control the transfers, or may only record the transfers that are initiated and controlled by another process.

The calculation module 105 records the number of transfers during a period of time, as described above. For example, during a twelve month period with recurring monthly transfers, the calculation module 105 may record a number of transfers. For a grace of two transfers, the calculation module 105 will calculate a bonus for the number of transfers above the threshold of ten transfers. The calculation module 105 may calculate the bonus based upon an average of the second account 103, or based upon a minimum or maximum balance of the second account 103, or may calculate the bonus independent of the value of the second account 103. As described above, the bonus may be a percent or a dollar amount, related to or independent of the balance of the second account 105.

The various techniques, methods, and systems described above can be implemented in part or in whole using computer-based systems and methods. Additionally, computer-based systems and methods can be used to augment or enhance the functionality described above, increase the speed at which the functions can be performed, and provide additional features and aspects as a part of or in addition to those described elsewhere in this document. Various computer-based systems, methods and implementations in accordance with the above-described technology are presented below.

In one implementation, a general-purpose computer can have an internal or external memory for storing data and programs such as an operating system (e.g., DOS, Windows 2000™, Windows XP™, Windows NT™, OS/2, UNIX or Linux) and one or more application programs. Examples of application programs include computer programs implementing the techniques described herein, authoring applications (e.g., word processing programs, database programs, spreadsheet programs, or graphics programs) capable of generating documents or other electronic content; client applications (e.g., an Internet Service Provider (ISP) client, an e-mail client, or an instant messaging (IM) client) capable of communicating with other computer users, accessing various computer resources, and viewing, creating, or otherwise manipulating electronic content; and browser applications (e.g., Microsoft's Internet Explorer) capable of rendering standard Internet content and other content formatted according to standard protocols such as the Hypertext Transfer Protocol (HTTP).

One or more of the application programs can be installed on the internal or external storage of the general-purpose computer. Alternatively, in another implementation, application programs can be externally stored in and/or performed by one or more device(s) external to the general-purpose computer.

The general-purpose computer includes a central processing unit (CPU) for executing instructions in response to commands, and a communication device for sending and receiving data. One example of the communication device is a modem. Other examples include a transceiver, a communication card, a satellite dish, an antenna, a network adapter, or some other mechanism capable of transmitting and receiving data over a communications link through a wired or wireless data pathway.

The general-purpose computer can include an input/output interface that enables wired or wireless connection to various peripheral devices. Examples of peripheral devices include, but are not limited to, a mouse, a mobile phone, a personal digital assistant (PDA), a keyboard, a display monitor with or without a touch screen input, and an audiovisual input device. In another implementation, the peripheral devices can themselves include the functionality of the general-purpose computer. For example, the mobile phone or the PDA can include computing and networking capabilities and function as a general purpose computer by accessing the delivery network and communicating with other computer systems. Examples of a delivery network include the Internet, the World Wide Web, WANs, LANs, analog or digital wired and wireless telephone networks (e.g., Public Switched Telephone Network (PSTN), Integrated Services Digital Network (ISDN), and Digital Subscriber Line (xDSL)), radio, television, cable, or satellite systems, and other delivery mechanisms for carrying data. A communications link can include communication pathways that enable communications through one or more delivery networks.

In one implementation, a processor-based system (e.g., a general-purpose computer) can include a main memory, preferably random access memory (RAM), and can also include a secondary memory. The secondary memory can include, for example, a hard disk drive and/or a removable storage drive, representing a floppy disk drive, a magnetic tape drive, an optical disk drive, etc. The removable storage drive reads from and/or writes to a removable storage medium. A removable storage medium can include a floppy disk, magnetic tape, optical disk, etc., which can be removed from the storage drive used to perform read and write operations. As will be appreciated, the removable storage medium can include computer software and/or data.

In alternative embodiments, the secondary memory can include other similar means for allowing computer programs or other instructions to be loaded into a computer system. Such means can include, for example, a removable storage unit and an interface. Examples of such can include a program cartridge and cartridge interface (such as the found in video game devices), a removable memory chip (such as an EPROM or PROM) and associated socket, and other removable storage units and interfaces, which allow software and data to be transferred from the removable storage unit to the computer system.

In one embodiment, the computer system can also include a communications interface that allows software and data to be transferred between computer system and external devices. Examples of communications interfaces can include a modem, a network interface (such as, for example, an Ethernet card), a communications port, and a PCMCIA slot and card. Software and data transferred via a communications interface are in the form of signals, which can be electronic, electromagnetic, optical or other signals capable of being received by a communications interface. These signals are provided to communications interface via a channel capable of carrying signals and can be implemented using a wireless medium, wire or cable, fiber optics or other communications medium. Some examples of a channel can include a phone line, a cellular phone link, an RF link, a network interface, and other suitable communications channels.

In this document, the terms “computer program medium” and “computer usable medium” are generally used to refer to media such as a removable storage device, a disk capable of installation in a disk drive, and signals on a channel. These computer program products provide software or program instructions to a computer system.

Computer programs (also called computer control logic) are stored in the main memory and/or secondary memory. Computer programs can also be received via a communications interface. Such computer programs, when executed, enable the computer system to perform the features as discussed herein. In particular, the computer programs, when executed, enable the processor to perform the described techniques. Accordingly, such computer programs represent controllers of the computer system.

In an embodiment where the elements are implemented using software, the software can be stored in, or transmitted via, a computer program product and loaded into a computer system using, for example, a removable storage drive, hard drive or communications interface. The control logic (software), when executed by the processor, causes the processor to perform the functions of the techniques described herein.

In another embodiment, the elements are implemented primarily in hardware using, for example, hardware components such as PAL (Programmable Array Logic) devices, application specific integrated circuits (ASICs), or other suitable hardware components. Implementation of a hardware state machine so as to perform the functions described herein will be apparent to a person skilled in the relevant art(s). In yet another embodiment, elements are implanted using a combination of both hardware and software.

In another embodiment, the computer-based methods can be accessed or implemented over the World Wide Web by providing access via a Web Page to the methods described herein. Accordingly, the Web Page is identified by a Universal Resource Locator (URL). The URL denotes both the server and the particular file or page on the server. In this embodiment, it is envisioned that a client computer system interacts with a browser to select a particular URL, which in turn causes the browser to send a request for that URL or page to the server identified in the URL. Typically the server responds to the request by retrieving the requested page and transmitting the data for that page back to the requesting client computer system (the client/server interaction is typically performed in accordance with the hypertext transport protocol or HTTP). The selected page is then displayed to the user on the client's display screen. The client can then cause the server containing a computer program to launch an application to, for example, perform an analysis according to the described techniques. In another implementation, the server can download an application to be run on the client to perform an analysis according to the described techniques.

Although the systems and methods have been described in detail, it will be apparent to those of skill in the art that the systems and methods can be embodied in a variety of specific forms and that various changes, substitutions, and alterations can be made without departing from the spirit and scope of the systems and methods described herein. The described embodiments are only illustrative and not restrictive and the scope of the systems and methods is, therefore, indicated by the following claims. Other embodiments are within the scope of the following claims.

What is claimed is:

1. A method for incentivizing saving comprising:
receiving a recurring transfer from a first account to a second account,
determining a number of recurring transfers received, and
adding a bonus to the second account calculated from an average balance of the second account,
wherein the bonus is added when the number of recurring transfers received is above a threshold during a period of time, thereby rewarding loyalty.

2. The method of claim 1, wherein the bonus is a percent of the average balance of the second account.

3. The method of claim 1, wherein the period of time is one year.

4. The method of claim 3, wherein the recurring transfer recurs substantially monthly.

5. The method of claim 4, wherein the threshold is ten.

6. The method of claim 4, wherein the threshold is eleven.

7. The method of claim 4, wherein the threshold is twelve.

8. A method for incentivizing saving comprising:
receiving a recurring transfer from a first account to a second account,
determining a number of recurring transfers received, and
adding a bonus to the second account calculated from a balance of the second account,
wherein the bonus is added when the number of recurring transfers received is above a threshold during a period of time, thereby rewarding loyalty.

9. The method of claim 8, wherein the bonus is a percent of the average balance of the second account.

10. The method of claim 8, wherein the bonus is a dollar amount related to the average balance of the second account.

11. The method of claim 8, wherein the bonus is a dollar amount independent of the balance of the second account.

12. A system for incentivizing savings comprising:
a first account;
a second account, receiving a recurring transfer from the first account; and
a calculation module configured to determine a number of recurring transfers received, and add a bonus to the second account calculated from a balance of the second account when the number of recurring transfers received is above a threshold during a period of time, thereby rewarding loyalty.

13. The system of claim 12, wherein the bonus is a percent of the average balance of the second account.

14. The system of claim 12, wherein the period of time is one year.

15. The system of claim 14, wherein the recurring transfer recurs monthly.

16. The system of claim 15, wherein the threshold is ten.

17. The system of claim 15, wherein the threshold is eleven.

18. The system of claim 15, wherein the threshold is twelve.

19. The system of claim 12, wherein the bonus is a percent of the average balance of the second account.

20. The system of claim 12, wherein the bonus is a dollar amount related to the average balance of the second account.

21. The system of claim 12, wherein the bonus is a dollar amount independent of the balance of the second account.
